(19) United States
(12) Patent Application Publication
(10) Pub. No.: US 2024/0233990 A1
(43) Pub. Date: Jul. 11, 2024

(54) NON-ORIENTED ELECTRICAL STEEL SHEET AND MANUFACTURING METHOD THE SAME

(71) Applicant: CHINA STEEL CORPORATION, KAOHSIUNG (TW)

(72) Inventors: Po-yu CHEN, KAOHSIUNG (TW); I-ching HSIAO, KAOHSIUNG (TW); Ming-chin TSAI, KAOHSIUNG (TW); Hsin-yi LEE, KAOHSIUNG (TW); Lin HSU, KAOHSIUNG (TW)

(21) Appl. No.: 18/524,393

(22) Filed: Nov. 30, 2023

(30) Foreign Application Priority Data
Jan. 5, 2023 (TW) 112100445

(51) Int. Cl. H01F 1/147; C21D 1/30; C21D 6/00; C21D 8/02; C21D 9/46; C22C 38/02; C22C 38/04; C22C 38/06; C22C 38/60

(52) U.S. Cl. CPC H01F 1/14775; C21D 1/30; C21D 6/005; C21D 6/008; C21D 8/0205; C21D 8/0226; C21D 8/0236; C21D 8/0263; C21D 9/46; C22C 38/02; C22C 38/04; C22C 38/06; C22C 38/60; C22C 2202/02

(57) ABSTRACT

A non-oriented electrical steel sheet with characteristics of high permeability, high magnetic flux, and low iron loss and a manufacturing method thereof are provided. The non-oriented electrical steel sheet includes an electrical steel, wherein the electrical steel includes the following compositions of: an amount of 0.005 wt. % or less of carbon, an amount of 0.005 wt. % or less of nitrogen, an amount of 0.005 wt. % or less of sulfur, an amount of 0.05 wt. % or less of phosphorus, an amount of 1.0 to 2.5 wt. % of silicon, an amount of 0.1 to 0.8 wt. % of aluminum, an amount of 0.1 to 0.8 wt. % of manganese, an amount of 0.01 to 0.10 wt. % of antimony and the balance of iron and other unavoidable impurities, wherein the electrical steel meets the following relationship: 20≤10*silicon content+11*aluminum content+6*manganese content≤30.

### CROSS-REFERENCE TO RELATED APPLICATIONS

100011 This application claims priority to Taiwan Patent Application No. 112100445, filed Jan. 5, 2023, the disclosures of which are herein incorporated by reference in their entirety.

### FIELD OF INVENTION

The present disclosure relates to non-oriented electrical steel sheets with characteristics of high permeability, high magnetic flux, and low iron loss and their manufacturing methods thereof, in particular to non-oriented electrical steel sheets with characteristics of high permeability, high magnetic flux, and low iron loss and their manufacturing methods thereof for providing various high-speed motors (such as motors for electric vehicles, hybrid electric vehicles, vacuum cleaners, drones, and tools).

### BACKGROUND OF INVENTION

In response to the increasingly stringent energy-saving policies of countries around the world, the demand for energy efficiency of various types of electric motors is increasing. From the perspective of iron core materials, switching directly from existing grades of electrical steel sheets to higher grades of products should meet the requirement of lower losses. However, in addition to the increasing material costs, the higher grade of electromagnetic steel also has higher strength, and the corresponding punch molds have to be updated and adjusted simultaneously, which increases the additional cost for motor manufacturers. Therefore, the development of more competitive low-loss and high-efficiency electrical steel sheets for motors has been a key research project for steel makers in recent years.

The operating losses of electric motors can be divided into iron loss and copper loss. The former is directly related to the basic iron loss characteristics of electrical steel sheets, and the iron loss can be achieved by controlling the specifications of hysteresis loss and eddy current loss; the latter is the loss (I²R) caused by the wire resistance (R), which is proportional to the square of the excitation current I, while the excitation current is related to the induced magnetic flux B and inversely proportional to the square of the permeability μ (1/μ²). Therefore, increasing the permeability and magnetic flux of the core material can effectively reduce the excitation current and obtain lower copper loss. Therefore, to meet the material requirements of high-efficient motors, the main goal of the research is to develop electrical steel sheets with characteristics of high magnetic conductivity, high magnetic flux, and low iron loss.

In order to improve the iron loss of electrical steel sheets, high Si—Al alloy is usually added to increase the resistance and obtain lower eddy current loss. However, this also dilutes the original ferromagnetism, causing the magnetic induction characteristics of the substrate, such as magnetic flux, and permeability under high magnetic fields, to deteriorate, making it difficult to balance both factors. For this technical difficulty, the existing technology needs further work.

For example, by performing appropriate deoxidation treatment in the RH refining process to control the distribution of inclusion morphology, and using intermediate annealing for the hot-rolled plates to optimize the grain size before the cold-rolling process, the permeability at 1.0 T and 1.5 T induced magnetic flux strengths can be improved. However, the cost of the RH process is relatively high, and the precipitates with smaller sizes have more severe interference with the movement of the magnetic domain wall compared to oxide inclusions. The effect of high temperature and short-time intermediate annealing on the precipitates modification is limited, so the degree of permeability optimization is not high.

In addition, the sulfur content in the molten iron is controlled through vacuum treatment during steelmaking, which maintains a specific proportion to copper. The size distribution of manganese sulfide and cuprous sulfide is controlled using appropriate temperature ranges during reheating of the hot-rolled steel billet, and the degradation effect of thermal stress on the magnetic domain direction is reduced through final annealing and slow cooling. However, the cost of vacuum treatment in steelmaking is relatively high, and in fact, the copper content in electrical steel sheets is extremely low. The main influencing factor is still manganese sulfide, and the intermediate annealing adopts high-temperature and short-term treatment, which has a limited optimization effect on improving precipitates.

Existing technology proposes to eliminate intermediate annealing of hot-rolled plates, and coarsen precipitates by controlling hot-rolling parameters, and promoting recrystallization growth of the micro-structure of the hot-rolled plate, thereby optimizing the texture, reducing magnetization resistance, and improving properties. However, eliminating the intermediate annealing process may reduce the process cost, but in essence, the degree of optimization of the characteristics is also limited, and the overall magnetic characteristics can hardly meet the demand for high-efficiency motors.

The existing technology further proposes that adding an appropriate amount of nickel may effectively improve the texture, increase the favorable magnetic orientation, reduce the magnetic deterioration orientation, and thereby obtain an improvement in magnetic permeability. However, the addition of 0.5 wt. % or more of nickel is required to achieve a significant improvement in permeability, which may result in a significant increase in steelmaking costs.

The basic concept of existing technologies for improving the permeability is to minimize magnetization barriers as much as possible, such as regulating inclusion and precipitate materials, and even adding other alloy elements to improve the magnetization characteristics of substrates. However, few comprehensive technological breakthroughs take into account all aspects of characteristics.

Therefore, it is necessary to provide a non-oriented electrical steel sheet with characteristics of high permeability, high magnetic flux, and low iron loss and the manufacturing method thereof, to solve the problems existing in conventional technologies.

### SUMMARY OF INVENTION

An aspect of the present invention is to provide a non-oriented electrical steel sheet with characteristics of high permeability, high magnetic flux, and low iron loss and manufacturing method thereof, which aims to find the optimal Si—Al ratio, to maintain ferromagnetism and grain growth ability, and to optimize intermediate annealing treatment to control of size distribution of texture and precipitation, thereby achieving over-specification iron loss performance with a lower total amount of Si—Al alloy, achieving the development of non-oriented electrical steel sheets with characteristics of high permeability, high magnetic flux, and low iron loss.

Another aspect of the present invention is to provide a non-oriented electrical steel sheet with characteristics of high permeability, high magnetic flux, and low iron loss, and a manufacturing method thereof. The stress relief annealing process may be carried out at the client for final annealing fine-tuning, so that no additional temper rolling process is required, and the iron loss may be significantly reduced after the stress relief annealing process, with a higher permeability level.

Another aspect of the present invention is to provide a non-oriented electrical steel sheet with characteristics of high permeability, high magnetic flux, and low iron loss, and a manufacturing method thereof, suitable for the production of non-oriented electrical steel sheets for high-efficiency motors under different working magnetic fields (0.1 T to 1.5 T). The electrical steel sheet may effectively reduce copper loss during operation, improve torque, and improve motor efficiency.

To achieve the above purposes, the present invention provides a non-oriented electrical steel sheet with characteristics of high permeability, high magnetic flux, and low iron loss, including an electrical steel, wherein the electrical steel includes the following compositions of: an amount of 0.005 wt. % or less of carbon, an amount of 0.005 wt. % or less of nitrogen, an amount of 0.005 wt. % or less of sulfur, an amount of 0.05 wt. % or less of phosphorus, an amount of 1.0 to 2.5 wt. % of silicon, an amount of 0.1 to 0.8 wt. % of aluminum, an amount of 0.1 to 0.8 wt. % of manganese, an amount of 0.01 to 0.10 wt. % of antimony and the balance of the iron and other unavoidable impurities, wherein the electrical steel meets the following relationship: 20≤10*silicon content+11*aluminum content+6*manganese content≤30.

In some embodiments, the characteristic of the electrical steel meets the following relationship: μ_{1/50}+μ_{10/50}+μ_{15/50}≥12000, wherein μ_{1/50}, μ_{10/50}, and μ_{15/50} are the relative permeabilities at 50 Hz for 0.1 T, 1.0 T, and 1.5 T induced magnetic flux states, respectively.

In some embodiments, the characteristic of the electrical steel meets the following relationship: B₁+B₁₀+B₅₀≥4.25 T, wherein B₁, B₁₀, and B₅₀ are induced magnetic flux with applied magnetic fields of 100 A/m, 1000 A/m, and 5000 A/m at 50 Hz, respectively.

In some embodiments, the characteristic of the electrical steel meets the following relationship: W_{15/50}≤3.1 W/kg, wherein W_{15/50} is the iron loss in a state of 1.5 T induced magnetic flux at 50 Hz.

In some embodiments, the characteristic of the electrical steel after performing a stress relief annealing step at 750° C. for 2 hours meets the following relationship: μ_{1/50}+μ_{10/50}+μ_{15/50}≥18000, wherein μ_{1/50}, μ_{10/50}, and μ_{15/50} are the relative permeability at 50 Hz for 0.1 T, 1.0 T, and 1.5 T induced magnetic flux states, respectively.

In some embodiments, the characteristic of the electrical steel after the stress relief annealing step at 750° C. for 2 hours meets the following relationship: ΔW_{15/50}=(W_{15/50,final product}−W_{15/50 after stress relief annealing})/(W_{15/50, final product})≥10%.

Furthermore, the present invention provides a manufacturing method of non-oriented electrical steel sheets with characteristics of high permeability, high magnetic flux, and low iron loss as described above, comprising the following steps: provide a steel billet, wherein the electrical steel comprises the following compositions of: an amount of 0.005 wt. % or less of carbon, an amount of 0.005 wt. % or less of nitrogen, an amount of 0.005 wt. % or less of sulfur, an amount of 0.05 wt. % or less of phosphorus, an amount of 1.0 to 2.5 wt. % of silicon, an amount of 0.1 to 0.8 wt. % of aluminum, an amount of 0.1 to 0.8 wt. % of manganese, an amount of 0.01 to 0.10 wt. % of antimony and the balance of the iron and other unavoidable impurities, wherein the electrical steel meets the following relationship: 20≤10*silicon content+11*aluminum content+6*manganese content≤30. performing a hot-rolling step to the steel billet to form a hot-rolled steel plate; performing a two-stage intermediate annealing treatment on the hot-rolled steel plate; performing a cold-rolling step to form a cold-rolled steel plate; and performing an annealing step to the cold-rolled steel plate to obtain an electrical steel sheet.

In some embodiments, performing the hot-rolling step further comprises the step of re-heating the steel billet, wherein the re-heating temperature of the steel billet in the hot-rolling step ranges from 1000 to 1200° C.

The manufacturing method according to claim 7, a finishing rolling temperature for the hot-rolling step ranges from 800 to 950° C. and a coil temperature ranges from 600 to 750° C.

The manufacturing method according to claim 7, the two-stage intermediate annealing treatment step further comprises a first annealing treatment step and a second annealing treatment step, wherein the annealing temperature of the first annealing treatment step ranges from 800 to 950° C. and the holding time ranges from 60 to 180 seconds; the annealing temperature of the second annealing treatment step ranges from 600 to 890° C., and the holding time ranges from 1 to 20 hours.

In some embodiments, the characteristic of the electrical steel meets the following relationship: μ_{1/50}+μ_{10/50}+μ_{15,50}≥12000, μ_{1/50}, μ_{10/50}, and μ_{15/50} are the relative permeabilities at 50 Hz for 0.1 T, 1.0 T, and 1.5 T induced magnetic flux states, respectively; B₁+B₁₀+B₅₀≥4.25 T, wherein B₁, B₁₀, and B₅₀ are induced magnetic flux with applied magnetic fields of 100 A/m, 1000 A/m, and 5000 A/m at 50 Hz, respectively; and W_{15/50}≤3.1 W/kg, wherein W_{15/50} is the iron loss in a state of 1.5 T induced magnetic flux at 50 Hz.

In some embodiments, the manufacturing method further comprises: performing a stress relief annealing step at 750° C. for 2 hours on the electrical steel sheet, and the characteristics of the electrical steel sheet after the stress relief annealing step meet the following relationship: μ_{1/50}+μ_{10/50}+μ_{15/50}≥18000, wherein μ_{1/50}, μ_{10/50}, and μ_{15/50} are the relative permeabilities at 50 Hz for 0.1 T, 1.0 T, and 1.5 T induced magnetic flux states, respectively; and ΔW_{15/50}=(W_{15/50, final product}−W_{15/50, after stress relief annealing})/(W_{15/50, final product})≥10%.

### DRAWINGS

In order to more clearly explain the technical solutions according to the embodiments of the present application, the following will briefly introduce the drawings that need to be used in the description of the embodiments. It is apparent that the drawings in the following description are only some embodiments of the present application. For those skilled in the art can obtain other drawings based on these drawings without any creative work.

FIG. 1 is a schematic flowchart of a manufacturing method of a non-oriented electrical steel sheet according to an embodiment of the present invention.

FIG. 2 is a schematic diagram of the effect of the total amount of silicon and aluminum in the electrical steel sheet of the present invention on the magnetization curve (B—H curve).

### DETAILED DESCRIPTION OF EMBODIMENTS

In order to make the above and other purposes, features, and advantages of the present invention more apparent and easy to understand, the following will provide preferred embodiments of the present invention and provide a detailed explanation accompanying with the attached drawings. Furthermore, the directional terms mentioned in the present invention, such as up, down, top, bottom, front, back, left, right, inside, outside, side, around, center, horizontal, lateral, vertical, longitudinal, axial, radial, uppermost or lowermost layers, are only referring to the direction of the attached drawings. Therefore, the directional terms used herein are for explaining and understanding the present invention, rather than limiting the scope of the present invention.

As used herein, a numerical range of a variable mentioned herein is to indicate that the variable is equal to any value within that range. Thus, for an inherently discontinuous variable, the variable is equal to any integer value within that range of values, including the endpoints of the range. Similarly, for an inherently continuous variable, the variable is equal to any real value within that range of values, including the endpoints of the range. As an example, rather than a limitation, a variable with a value between 0 and 2, if the variable itself is discontinuous, it is described as taking the value of 0, 1, or 2, if the variable itself is continuous, then it is described as taking the value of 0.0, 0.1, 0.01, 0.001 or any other real value ≥0 and ≥2.

Unless otherwise specified, “a” and “the” may refer to either a single or a plural number. The serial numbers used in the steps are only used to indicate the steps for ease of explanation, not to limit the sequence and manner of implementation. Furthermore, the terms ‘comprise’, ‘include’, ‘have’. ‘containing’, and so on used herein are all open-ended terms, meaning including but not limited to.

The present invention provides a non-oriented electrical steel sheet with characteristics of high permeability, high magnetic flux, and low iron loss, which includes an electrical steel, wherein the electrical steel includes the following compositions of: an amount of 0.005 wt. % or less of carbon, an amount of 0.005 wt. % or less of nitrogen, an amount of 0.005 wt. % or less of sulfur, an amount of 0.05 wt. % or less of phosphorus, an amount of 1.0 to 2.5 wt. % of silicon, an amount of 0.1 to 0.8 wt. % of aluminum, an amount of 0.1 to 0.8 wt. % of manganese, an amount of 0.01 to 0.10 wt. % of antimony and the balance of the iron and other unavoidable impurities, where the electrical steel meets the following relationship (1):

X=10Si+11Al+6Mn,X:20-30 (1)

In other words, the alloy content of the electrical steel meets the requirement of: 20≤*silicon content+11*aluminum content+6*manganese content≤30.

Moreover, the characteristics of the finished product of the non-oriented electrical steel sheet according to the present invention further meet the following relationships (2) to (4):

μ_{1/50}+μ_{10/50}+μ_{15/50}≥12000 (2)

B₁+B₁₀+B₅₀≥4.25T (3)

W_{15/50}≤3.1W/kg (4)

In which μ_{1/50}, μ_{10/50}, and μ_{5/50} are the relative permeability under 0.1 T, 1.0 T, and 1.5 T induced magnetic flux conditions at 50 Hz, while B₁, B₁₀, and B₅₀ are the induced magnetic flux under 100 A/m, 1000 A/m, and 5000 A/m applied magnetic fields at 50 Hz, respectively. W_{15/50} is the iron loss under 1.5 T induced magnetic flux condition at 50 Hz.

Furthermore, the characteristics of the non-oriented electrical steel sheet according to the present invention after the stress relief annealing (SRA) process meet the following relationships (5) to (6):

μ_{1/50}+μ_{10/50}+μ_{15/50}≥18000 (5)

ΔW_{15/50}=(W_{15/50,final product}−W_{15/50,SRA})/(W_{15/50,final product})≥10% (6)

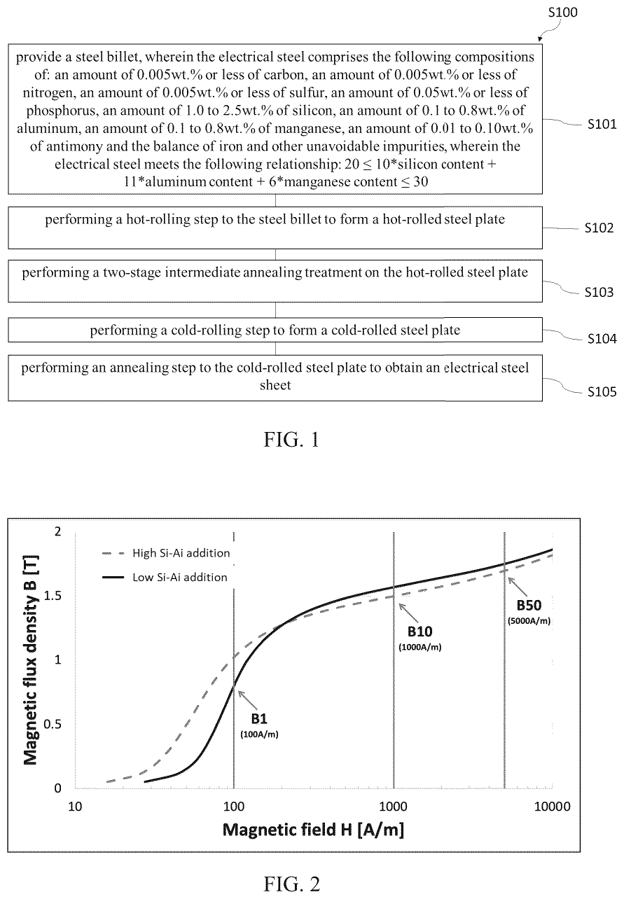

In addition, referring to FIG. 1, which shows the schematic flowchart of a manufacturing method of a non-oriented electrical steel sheet according to an embodiment of the present invention. The manufacturing method includes the following steps: Step S101, providing a steel billet, wherein the electrical steel comprises the following compositions of: an amount of 0.005 wt. % or less of carbon, an amount of 0.005 wt. % or less of nitrogen, an amount of 0.005 wt. % or less of sulfur, an amount of 0.05 wt. % or less of phosphorus, an amount of 1.0 to 2.5 wt. % of silicon, an amount of 0.1 to 0.8 wt. % of aluminum, an amount of 0.1 to 0.8 wt. % of manganese, an amount of 0.01 to 0.10 wt. % of antimony and the balance of iron and other unavoidable impurities, wherein the electrical steel meets the following relationship: 20≤10*silicon content+11*aluminum content+6*manganese content≤30. Step S102, performing a hot-rolling step to the steel billet to form a hot-rolled steel plate: Step S103, performing a two-stage intermediate annealing treatment on the hot-rolled steel plate; Step S104, performing a cold-rolling step to form a cold-rolled steel plate; and Step S105, performing an annealing step to the cold-rolled steel plate to obtain an electrical steel sheet.

In some embodiments, the re-heating temperature of the steel billet in the hot-rolling step ranges from 1000 to 1200° C., the finishing rolling temperature ranges from 800 to 950° C., and the coil temperature ranges from 600 to 750°, and the two-stage intermediate annealing treatment step further comprises a first annealing treatment step and a second annealing treatment step, wherein the annealing temperature of the first annealing treatment step ranges from 800 to 950° C., the holding time is 60 to 180 seconds, and the annealing temperature of the second annealing treatment step ranges from 600 to 890° C., the holding time is 1 to 20 hours.

In some embodiments, the characteristic of the electrical steel meets the following relationship: μ_{1/50}+μ_{10/50}+μ_{15/50}≥12000, wherein μ_{1/50}, μ_{15/50}, and μ_{15/50} are the relative permeabilities at 50 Hz for 0.1 T, 1.0 T, and 1.5 T induced magnetic flux states, respectively; B₁+B₁₀+B₅₀≥4.25 T, wherein B₁, B₁₀, and B₅₀ are induced magnetic flux with applied magnetic fields of 100 A/m, 1000 A/m, and 5000 A/m at 50 Hz, respectively, and W_{15/50}≤3.1 W/kg, wherein W_{15/50} is the iron loss in a state of 1.5 T induced magnetic flux at 50 Hz.

In some embodiments, the manufacturing method further comprises: performing a stress relief annealing step at 750° C. for 2 hours on the electrical steel sheet, and the characteristics of the electrical steel sheet after the stress relief annealing step meet the following relationship: μ_{1/50}+μ_{10/50}+μ_{15/50}≥18000, wherein μ_{1/50}, μ_{10/50}, and μ_{15/50} are the relative permeabilities at 50 Hz for 0.1 T, 1.0 T, and 1.5 T induced magnetic flux states, respectively; and ΔW_{15/50}=(W_{15/50, final product}−W_{15/50, after stress annealing})/(W_{15/50, final product})≥10%.

The following content provides a detailed description of the design concept of the present invention.

Referring to FIG. 2, which shows the schematic diagram of the effect of the total amount of silicon and aluminum in the electrical steel sheet on the magnetization curve (B—H curve).

The electrical steel sheets, as the core material of electric motors, have two main characteristics that affect the energy efficiency performance of the motor. One is the iron loss, and the other is the magnetic susceptibility (copper loss). Generally, the specifications of electrical steel sheets used in motors are represented by the iron loss W_{15/50} under common working magnetic flux (1.5 T), while the magnetic susceptibility is represented by the nearly saturated magnetic flux B50. However, according to research, in addition to the motor operating losses at 1.5 T, depending on the motor type, the losses during the start-up process (0-1.5 T) are also a key consideration for energy efficiency. However, as shown in FIG. 2, the influence of high and low Si—Al content on the magnetization curve (B—H curve) under conventional manufacturing processes is reversed. High Si—Al has a higher initial magnetic flux that is susceptible to magnetization, but it has a lower magnetic flux in the middle and later stages. Low Si—Al has the opposite trend, and both do not fully meet the needs of high-efficiency motors. If high magnetic flux and high permeability performance under different magnetic fields may be achieved simultaneously, while low iron loss characteristics may be maintained, the energy efficiency of the motor may be effectively improved. Therefore, the present invention configures the relationship formulas (2) to (6) for characteristics of the permeability, magnetic flux, and iron loss under different working conditions to meet the efficiency improvement requirements of high-efficiency motors, to avoid focusing on specific conditions without optimizing the energy efficiency.

According to metallurgical principles, the iron loss of electrical steel sheets may be divided into hysteresis loss and eddy current loss. The latter is inversely proportional to the resistivity. Therefore, the addition of Si—Al alloy elements to increase resistance may effectively reduce eddy current loss. The former is inversely proportional to the grain size and magnetization hindrance, and the larger the grain size and the less hindrance, the lower the hysteresis loss. The addition of Si—Al may directly lead to the deterioration of induced magnetic flux and permeability under high magnetic fields. Moreover, a large number of Si—Al atoms in a solid solution may have a retarded and hindered solute drag effect on the nucleation growth of the substrate, and the higher the Si—Al addition, the higher the recrystallization temperature may be. In addition, aluminum also has the effect of generating AlN precipitates to pin grain boundaries. Those may interfere with the optimization of hysteresis loss.

Therefore, through in-depth research, the present invention identifies key technologies that may simultaneously meet the aforementioned iron loss, permeability, and magnetic flux characteristics, including determining the optimal range of alloy content, and optimizing the intermediate annealing process to achieve texture optimization and precipitation size distribution control.

First, the present invention sets the optimal addition range of the main alloy element Si—Al—Mn for electrical steel sheets used in electric motors (i.e. the above relationship formula (1). After setting the composition within this range, it may retain a considerable contribution of resistivity (eddy current loss), and maintain sufficient ferromagnetism to maintain good magnetic susceptibility in the middle and later stages of magnetization. On the other hand, it may also be controlled to avoid the obstruction of grain growth caused by high alloy content (hysteresis loss).

However, the addition of high Si—Al may reduce the magnetic anisotropy of iron-based materials, resulting in higher permeability and induced magnetic flux in the initial stage of magnetization. The inventor found that due to the significant movement and mutual annexation of the magnetic domain walls during the initial magnetization stage, if the obstruction of precipitates may be reduced, even the alloy design with low Si—Al addition has the opportunity to achieve high permeability and high induced magnetic flux under low external magnetic fields. In general, the control methods of precipitates are as follows: controlling the content of the elements formed by precipitates, such as Ti, Nb, and V, limiting their total amount, and combining with extremely low C and N concentrations to reduce their formation; or reducing the reheating temperature of the hot rolled steel billet, so that the precipitation may be reduced and further refined.

However, the present invention does not specifically control this portion of the process, which may effectively reduce steelmaking costs and hot-rolling process pressure. The present invention adopts a specialized intermediate annealing process, which first completes the recrystallization growth of hot-rolled plate grains by high-temperature short-time annealing (holding at 800 to 950° C. for 60 to 180 seconds). Before cold-rolling, a complete coarsened grain structure may retain more magnetic advantageous orientations in the subsequent development of the texture, such as (110) and (001), and then that undergoes low-temperature long-term heat treatment (holding at 600 to 890° C. for 1 to 20 hours), which enables the precipitations in the base to coarsen and grow, and enables the added trace elements such as Sb to segregate at grain boundaries, and optimizes the texture (which increases magnetic favorable orientation grains and reducing degraded orientation (111) grains). After this specialized intermediate annealing, the size distribution of precipitates may be effectively improved, the magnetization hindrance may be reduced, and a considerable excellent effect on improving the aggregate structure may be achieved.

In addition, due to the appropriate addition of alloy and the control of precipitation size distribution, these two mechanisms may effectively improve grain growth ability. Therefore, according to customer needs, more excellent iron loss and permeability performance may be achieved after stress relief annealing at the client end. Another advantage of the present invention is that it may directly achieve similar characteristics and behavior of semi-processed electrical steel sheets without additional temper rolling, or inclusion control processes, and the characteristics of the electrical steel sheet are excellent before and after the stress relief annealing process.

Table 1 provides several specific examples of the present invention and comparative examples to illustrate and verify that the compositions of the steel billets are designed according to the X-value calculation method of the present invention, and processed through different intermediate annealing treatment steps.

The composition of the steel billets shown in Table 1 is ordered by the total amount of Si—Al added and calculated according to the X-value proposed in the present invention. Comparative examples 1 and 2 are high Si—Al content, while comparative example 5 has low Si—Al, both of which have X values falling outside the scope of the invention. Table 1 also lists the process parameters of the intermediate annealing process for the steel billets after hot-rolling. Except for Examples 1 to 3, where a special two-stage intermediate annealing process are subjected, the other comparative examples are subjected to a general high temperature and short time intermediate annealing process.

TABLE 1
Composition of samples and process parameters of the intermediate annealing process

| | C | Mn | Si | Al | Sb | X | Intermediate |
|---|---|---|---|---|---|---|---|
| sample | (wt %) | (wt %) | (wt %) | (wt %) | (wt %) | (20-30) | annealing |
| Comparative | 0.0026 | 0.14 | 2.69 | 0.48 | 0.010 | 33.5 | 950° C., 60 seconds |
| Example 1 | | | | | | | |
| Comparative | 0.0030 | 0.60 | 2.42 | 0.29 | 0.010 | 31.0 | 900° C., 120 seconds |
| Example 2 | | | | | | | |
| Comparative | 0.0036 | 0.26 | 2.04 | 0.30 | 0.015 | 25.3 | 950° C., 60 seconds |
| Example 3 | | | | | | | |
| Comparative | 0.0033 | 0.26 | 1.76 | 0.28 | 0.015 | 22.2 | 900° C., 120 seconds |
| Example 4 | | | | | | | |
| Example 1 | 0.0019 | 0.23 | 1.85 | 0.30 | 0.015 | 23.2 | 900° C., 120 seconds + |
| | | | | | | | 850° C., 5 hours |
| Example 2 | 0.0021 | 0.31 | 1.56 | 0.30 | 0.035 | 20.7 | 900° C., 120 seconds + |
| | | | | | | | 850° C., 5 hours |
| Example 3 | 0.0036 | 0.40 | 1.59 | 0.30 | 0.035 | 21.6 | 900° C., 120 seconds + |
| | | | | | | | 850° C., 5 hours |
| Comparative | 0.0018 | 0.22 | 1.16 | 0.21 | 0.035 | 15.3 | 900° C., 120 seconds |
| Example 5 | | | | | | | |

Table 2 shows the characteristic measurements of the cold-rolled plates that are subjected to a cold-rolling step to 0.5 mm after the intermediate annealing process and subjected to the stress relief annealing step to form the final product state. Comparative example 1 is a high Si—Al addition, with a high X value. Although the iron loss and permeability of the finished product show good performance, the permeability after the stress relief annealing step is not ideal, and the decrease of iron loss ΔW_{15/50} is also relatively low. The main reason is that the high amount of alloy interferes with grain growth, and there is no optimization adjustment for precipitates. Comparative example 2 also is high Si—Al addition, and the intermediate annealing process is a conventional high-temperature and short-time process, with a lower temperature, resulting in poor overall performance.

Comparative examples 3 and 4 are samples with relatively low alloy content, and the X value is already within the range of the present invention. However, using the general intermediate annealing process as a comparison, it can be seen from Table 2 that the magnetic flux and permeability of the finished product are relatively close to the target value, the iron loss reduction after the stress relief annealing process is significantly higher than that of high alloy content comparative examples 1 and 2, and the permeability is also better. This is the improvement effect brought by appropriate but not too high alloy addition. However, the overall characteristics are still slightly insufficient. Example 1 and Comparative Examples 3 and 4 are similar in composition, which meets the X-value setting. Moreover, the intermediate annealing process adopts a specific two-stage process. The results show that the magnetic flux and permeability of the finished product have slightly improved, which is achieving the target specification. After the stress relief annealing process, a decrease of 12.8% in iron loss is observed. The iron loss after annealing is equivalent to that of Comparative Example 1, which has high alloy amounts, and the total permeability reaches 18158, which is much higher than the previous comparative examples.

Moreover, in Examples 2 to 3, the alloy contents slightly reduce and also meet the X value, and a specialized intermediate annealing process was adopted. The iron loss of the finished product was comparable to that of Examples 3 and 4, which have slightly higher alloy content, but the magnetic flux and permeability are better. After the stress relief annealing process, due to the appropriate alloy content and specialized intermediate annealing effect, they have good grain growth ability and precipitation control and achieved excellent characteristic feedback in both iron loss and permeability.

Comparative Example 5 is a control group with a low alloy content, whose X value is below the set range. In addition, it adopts a general intermediate annealing process. Although it has better grain growth ability due to the low alloy content, the improvement in iron loss and magnetic permeability after the stress relief annealing process is quite good. However, because the alloy content is low, the iron loss of the finished product is relatively high, and it does not meet the characteristic specifications of the present invention.

TABLE 2
Characteristics and performances of the samples

| | | Characteristics of the finished product | | | SRA characteristics | | |
|---|---|---|---|---|---|---|---|
| | | | B₁ + B₁₀ + | μ_{1/50} + μ_{10/50} + | | | μ_{1/50} + μ_{10/50} + |
| | X | W_{15/50[W/kg]} | B_{50 [T]} | μ_{15/50} | | ΔW_{15/50} | μ_{15/50} |
| sample | (20-30) | (≤3.1) | (≥4.25) | (≥12000) | W_{15/50[W/kg]} | (≥10%) | (≥18000) |
| Comparative | 33.5 | 2.77 | 4.22 | 12771 | 2.53 | 8.8% | 16293 |
| Example 1 | | | | | | | |
| Comparative | 31.0 | 2.97 | 4.12 | 10627 | 2.75 | 7.3% | 14106 |
| Example 2 | | | | | | | |
| Comparative | 25.3 | 2.99 | 4.24 | 11705 | 2.65 | 11.3% | 17321 |
| Example 3 | | | | | | | |
| Comparative | 22.2 | 3.08 | 4.21 | 11416 | 2.79 | 9.4% | 15978 |
| Example 4 | | | | | | | |
| Example 1 | 23.2 | 2.95 | 4.27 | 12608 | 2.57 | 12.8% | 18158 |
| Example 2 | 20.7 | 2.95 | 4.35 | 13492 | 2.55 | 13.4% | 19317 |
| Example 3 | 21.6 | 2.93 | 4.32 | 13129 | 2.60 | 11.4% | 18609 |
| Comparative | 15.3 | 3.31 | 4.20 | 11568 | 2.88 | 13.0% | 18029 |
| Example 5 | | | | | | | |

In summary, the present invention provides a final product, a non-oriented electrical steel sheet, and manufacturing method thereof, that has characteristics of high permeability, high magnetic flux, and low iron loss after the stress relief annealing process, the present invention aims to configure the optimal Si—Al ratio, to maintain ferromagnetism and grain growth ability, and to optimize intermediate annealing treatment so as to control of size distribution of texture and precipitation, thereby achieving over-specification iron loss performance with a lower total amount of Si—Al alloy. These non-oriented electrical steel sheets may be applied to the high-efficiency motor under different working magnetic fields (0.1 T-1.5 T), they can effectively reduce operating losses and improve energy efficiency.

What is claimed is:

1. A non-oriented electrical steel sheet with characteristics of high permeability, high magnetic flux, and low iron loss, comprising:
an electrical steel, wherein the electrical steel comprises the following compositions of: an amount of 0.005 wt. % or less of carbon, an amount of 0.005 wt. % or less of nitrogen, an amount of 0.005 wt. % or less of sulfur, an amount of 0.05 wt. % or less of phosphorus, an amount of 1.0 to 2.5 wt. % of silicon, an amount of 0.1 to 0.8 wt. % of aluminum, an amount of 0.1 to 0.8 wt. % of manganese, an amount of 0.01 to 0.10 wt. % of antimony and the balance of iron and other unavoidable impurities,
wherein the electrical steel meets the following relationship: 20≤10*silicon content+11*aluminum content+6*manganese content≤30.

2. The non-oriented electrical steel sheet according to claim 1, wherein the characteristic of the electrical steel meets the following relationship: μ_{1/50}+μ_{10/50}+μ_{15/50}≥1200, wherein μ_{1/50}, μ_{10/50}, and μ_{15/50} so are the relative permeabilities at 50 Hz for 0.1 T, 1.0 T, and 1.5 T induced magnetic flux states, respectively.

3. The non-oriented electrical steel sheet according to claim 1, wherein the characteristic of the electrical steel meets the following relationship: B₁+B₁₀+B₅₀≥4.25 T, wherein B₁, B₁₀, and B₅₀ are induced magnetic flux with applied magnetic fields of 100 A/m, 1000 A/m, and 5000 A/m at 50 Hz, respectively.

4. The non-oriented electrical steel sheet according to claim 1, wherein the characteristic of the electrical steel meets the following relationship: W_{15/50}≤3.1 W/kg, wherein W_{15/50} is the iron loss in a state of 1.5 T induced magnetic flux at 50 Hz.

5. The non-oriented electrical steel sheet according to claim 1, wherein the characteristic of the electrical steel after performing a stress relief annealing step at 750° C. for 2 hours meets the following relationship; μ_{1/50}+μ_{10/50}+μ_{15/50}≥18000, wherein μ_{1/50}, μ_{10/50}, and μ_{15/50} are the relative permeability at 50 Hz for 0.1 T, LOT, and 1.5 T induced magnetic flux states, respectively.

6. The non-oriented electrical steel sheet according to claim 5, wherein the characteristic of the electrical steel after a stress relief annealing step at 750° C. for 2 hours meets the following relationship: ΔW_{15,50}=(W_{15,50, final product}−W_{15/50, after stress relief annealing})/(W_{15/50, final product})≥10%.

7. An electrical steel, comprising:
a compositions of: an amount of 0.005 wt. % or less of carbon, an amount of 0.005 wt. % or less of nitrogen, an amount of 0.005 wt. % or less of sulfur, an amount of 0.05 wt. % or less of phosphorus, an amount of 1.0 to 2.5 wt. % of silicon, an amount of 0.1 to 0.8 wt. % of aluminum, an amount of 0.1 to 0.8 wt. % of manganese, an amount of 0.01 to 0.10 wt. % of antimony and the balance of iron and other unavoidable impurities,
wherein the electrical steel meets the following relationship: 20≤10*silicon content+11*aluminum content+6*manganese content≤30.

8. The electrical steel according to claim 7, wherein the characteristic of the electrical steel meets the following relationship: μ_{1/50}+μ_{10/50}+μ_{15/50}≥12000, wherein μ_{1/50}, μ_{10/50}, and μ_{15/50} are the relative permeabilities at 50 Hz for 0.1 T, 1.0 T, and 1.5 T induced magnetic flux states, respectively.

9. The electrical steel according to claim 7, wherein the characteristic of the electrical steel meets the following relationship: B₁+B₁₀+B₅₀≥4.25 T, wherein B₁, B₁₀, and B₅₀ are induced magnetic flux with applied magnetic fields of 100 A/m, 1000 A/m, and 5000 A/m at 50 Hz, respectively.

10. The electrical steel according to claim 7, wherein the characteristic of the electrical steel meets the following relationship: W_{15/50}≤3.1 W/kg, wherein W_{15/50} is the iron loss in a state of 1.5 T induced magnetic flux at 50 Hz.

11. The electrical steel according to claim 7, wherein the characteristic of the electrical steel after performing a stress relief annealing step at 750° C. for 2 hours meets the following relationship: μ_{1/50}+μ_{10/50}+μ_{15/50}≥18000, wherein μ_{1/50}, μ_{10/50}, and μ_{15/50} are the relative permeability at 50 Hz for 0.1 T, 1.0 T, and 1.5 T induced magnetic flux states, respectively.

12. The electrical steel according to claim 11, wherein the characteristic of the electrical steel after the stress relief annealing step at 750° C. for 2 hours meets the following relationship: ΔW_{15/50}=(W_{15,50, final product}−W_{15/50, after stress relief annealing})/(W_{15/50, final product})≥10%.

13. A manufacturing method for the electrical steel sheet according to claim 1, comprising the following steps:
provide a steel billet, wherein the steel billet comprises the following compositions of: an amount of 0.005 wt. % or less of carbon, an amount of 0.005 wt. % or less of nitrogen, an amount of 0.005 wt. % or less of sulfur, an amount of 0.05 wt. % or less of phosphorus, an amount of 1.0 to 2.5 wt. % of silicon, an amount of 0.1 to 0.8 wt. % of aluminum, an amount of 0.1 to 0.8 wt. % of manganese, an amount of 0.01 to 0.10 wt. % of antimony and the balance of iron and other unavoidable impurities, wherein the steel billet meets the following relationship: 20≤10*silicon content+11*aluminum content+6*manganese content≤30;
performing a hot-rolling step to the steel billet to form a hot-rolled steel plate;
performing a two-stage intermediate annealing treatment on the hot-rolled steel plate;
performing a cold-rolling step to form a cold-rolled steel plate; and
performing an annealing step to the cold-rolled steel plate to obtain an electrical steel sheet.

14. The manufacturing method according to claim 13, wherein performing the hot-rolling step further comprises the step of re-heating the steel billet, wherein the re-heating temperature of the steel billet in the hot-rolling step ranges from 1000 to 1200° C.

15. The manufacturing method according to claim 13, wherein a finishing rolling temperature for the hot-rolling step ranges from 800 to 950° C. and a coil temperature ranges from 600 to 750° C.

16. The manufacturing method according to claim 13, wherein the two-stage intermediate annealing treatment step further comprises: performing a first annealing treatment step the annealing temperature of the first annealing treatment step ranges from 800 to 950° C., and the holding time ranges from 60 to 180 seconds.

17. The manufacturing method according to claim 16, wherein the two-stage intermediate annealing treatment step further comprises: performing a second annealing treatment step, the annealing temperature of the second annealing treatment step ranges from 600 to 890° C., and the holding time ranges from 1 to 20 hours

18. The manufacturing method according to claim 13, wherein the manufacturing method further comprises: performing a stress relief annealing step at 750° C. for 2 hours on the electrical steel sheet.

19. The manufacturing method according to claim 18, wherein the characteristics of the electrical steel sheet after the stress relief annealing step meet the following relationship: μ_{1/50}+μ_{10/50}+μ_{15/50}≥18000, wherein μ_{1/50}, μ_{10/50}, and μ_{15,50} are the relative permeabilities at 50 Hz for 0.1 T, 1.0 T, and 1.5 T induced magnetic flux states, respectively; and ΔW_{15/50}=(W_{15/50, final product}−W_{15/50, after stress relief annealing})/(W_{15/50, final product})≥10%.

20. The manufacturing method according to claim 13, wherein the characteristic of the electrical steel sheet meets the following relationship: W_{15,50}≤3.1 W/kg, wherein W_{15/50} is the iron loss in a state of 1.5 T induced magnetic flux at 50 Hz.
